(19) United States
(12) Patent Application Publication
(10) Pub. No.: US 2026/0219935 A1
(43) Pub. Date: Jul. 30, 2026

(54) ARTIFICIAL INTELLIGENCE CO-PILOT SYSTEM AND METHODS THEREOF FOR INFORMATION TECHNOLOGY SYSTEMS

(71) Applicant: BigPanda, Inc., Redwood City, CA (US)

(72) Inventors: Alexander PAGE, Orlando, FL (US); Omri TELEM, Ness Ziona (IL); Nathan GROBLEWSKI, Franklin, TN (US); Jason Andrew WALKER, Victor, MT (US)

(73) Assignee: BigPanda, Inc., Redwood City, CA (US)

(21) Appl. No.: 19/038,155

(22) Filed: Jan. 27, 2025

(51) Int. Cl. G06F 9/50; G06N 3/0475

(52) U.S. Cl. CPC G06F 9/5027; G06N 3/0475

(57) ABSTRACT

A system and method for incident management in a computing environment utilizing generative artificial intelligence (AI) system is presented. The method includes receiving an incident input, the incident associated with a computing environment including a plurality of data sources; selecting an action plan of a plurality of predefined actions plans based on a result of processing a prompt, the context, and the incident input by the generative AI system, the action plan including a plurality of actions; generating a context for a generative AI model based on the incident input and data from at least a data source of the plurality of data sources; and executing at least an action of the action plan in the computing environment.

### TECHNICAL FIELD

The present disclosure relates generally to artificial intelligence (AI) co-pilots, and specifically to incident management in information technology systems utilizing AI co-pilots.

### BACKGROUND

A co-pilot is an artificial intelligence (AI) -powered assistant that helps humans perform tasks in a computing environment. A co-pilot often includes a generative AI which analyzes code, provides suggestions in response to detecting actions, provides auto-completions, and the like, which are aimed to save time and improve productivity. Co-pilots can assist with learning new programming languages, solving complex problems, or reducing repetitive tasks, making them valuable tools for both beginners and experienced developers.

However, a challenge of using a co-pilot is ensuring the accuracy and reliability of its suggestions. Since it relies on patterns from existing codebases, it might propose inefficient, insecure, or non-optimal solutions. Developers must carefully review and test its output to avoid introducing bugs or vulnerabilities, while use for querying might lead to imperfect or even false results.

Incident management in information technology (IT) is the process of identifying, analyzing, and resolving disruptions or issues in IT services to restore normal operations as quickly as possible. It ensures minimal impact on business operations and often involves steps like incident detection, logging, prioritization, diagnosis, resolution, and closure. Effective incident management helps maintain service reliability and user satisfaction, often supported by frameworks like ITIL (Information Technology Infrastructure Library).

A key challenge in incident management is ensuring clear communication and coordination among teams, especially during high-severity incidents. Miscommunication or delays in sharing critical information can prolong resolution times and escalate the impact. Additionally, balancing the urgency of immediate fixes with the need for long-term solutions can be difficult, as quick fixes may introduce recurring issues.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving an incident input, the incident associated with a computing environment including a plurality of data sources; selecting an action plan of a plurality of predefined action plans based on a result of processing a prompt, the context, and the incident input by the generative AI system, the action plan including a plurality of actions; generating a context for a generative AI model based on the incident input and data from at least a data source of the plurality of data sources; and executing at least an action of the action plan in the computing environment. Other embodiments of this aspect include corresponding computer systems, apparatus, and computer programs recorded on one or more computer storage devices, each configured to perform the actions of the methods.

Implementations may include one or more of the following features. The method may include: modifying an action of the action plan based on the received incident input. The method may include: generating a prompt for the generative AI system which when processed by the AI model outputs a modified action of the action plan. The method may include: generating the context based on a plurality of data sources. The method may include: extracting a plurality of data elements from each of the plurality of data sources, each data element ranked by similarity to at least the incident input; re-ranking the plurality of data elements to reduce redundancy based on at least a data source; and generating the context based on a group of re-ranked data elements of the plurality of data elements. The method may include: generating a plurality of data groups, each data group including a group of data sources of the plurality of data sources; and re-ranking the plurality of data elements further based on at least a data group. The method may include: selecting a data element of a data source based on a similarity ranking to the received incident input. The method may include: generating a vector representation of the data element; generating a vector representation of the incident input; and determining the similarity ranking based on a distance between the vector representation of the data element and the vector representation of the incident input. The method may include: configuring the generative AI system to generate vector representations based at least on a schema of a vector database. Implementations of the described techniques may include hardware, a method or process, or a computer tangible medium.

In one general aspect, a non-transitory computer - readable medium may include one or more instructions that, when executed by one or more processing circuitries of a device, cause the device to: receive an incident input, the incident associated with a computing environment including a plurality of data sources. The non-transitory computer-readable medium may also select an action plan of a plurality of predefined action plans based on a result of processing a prompt, the context, and the incident input by the generative AI system, the action plan including a plurality of actions. Medium may furthermore generate a context for a generative AI model based on the incident input and data from at least a data source of the plurality of data sources. Medium may in addition execute at least an action of the action plan in the computing environment. Other embodiments of this aspect include corresponding computer systems, apparatus, and computer programs recorded on one or more computer storage devices, each configured to perform the actions of the methods.

In one general aspect, a system may include one or more processing circuitries configured to:. The system may also receive an incident input, the incident associated with a computing environment including a plurality of data sources. The system may furthermore select an action plan of a plurality of predefined actions plans based on a result of processing a prompt, the context, and the incident input by the generative AI system, the action plan including a plurality of actions. The system may in addition generate a context for a generative AI model based on the incident input and data from at least a data source of the plurality of data sources. The system may moreover execute at least an action of the action plan in the computing environment. Other embodiments of this aspect include corresponding computer systems, apparatus, and computer programs recorded on one or more computer storage devices, each configured to perform the actions of the methods.

Implementations may include one or more of the following features. The system where the one or more processing circuitries are further configured to: modify an action of the action plan based on the received incident input. The system where the one or more processing circuitries are further configured to: generate a prompt for the generative AI system which when processed by the AI model outputs a modified action of the action plan. The system where the one or more processing circuitries are further configured to: generate the context based on a plurality of data sources. The system where the one or more processing circuitries are further configured to: extract a plurality of data elements from each of the plurality of data sources, each data element ranked by similarity to at least the incident input; re-rank the plurality of data elements to reduce redundancy based on at least a data source; and generate the context based on a group of re-ranked data elements of the plurality of data elements. The system where the one or more processing circuitries are further configured to: generate a plurality of data groups, each data group including a group of data sources of the plurality of data sources; and re-rank the plurality of data elements further based on at least a data group. The system where the one or more processing circuitries are further configured to: select a data element of a data source based on a similarity ranking to the received incident input. The system where the one or more processing circuitries are further configured to: generate a vector representation of the data element; generate a vector representation of the incident input; and determine the similarity ranking based on a distance between the vector representation of the data element and the vector representation of the incident input. The system where the one or more processing circuitries are further configured to: configure the generative AI system to generate vector representations based at least on a schema of a vector database. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of an artificial intelligence (AI) co-pilot system for incident management, implemented in accordance with an embodiment.

FIG. 2 is an example flowchart of a method for selecting an action plan in incident management, implemented in accordance with an embodiment.

FIG. 3 is an example flowchart of a method for increasing efficacy of generating a response to a user query utilizing a generative artificial intelligence, implemented in accordance with an embodiment.

FIG. 4 is an example flowchart of a method for improving retrieval augmented generation for a generative artificial intelligence system, implemented according to an embodiment.

FIG. 5 is an example schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

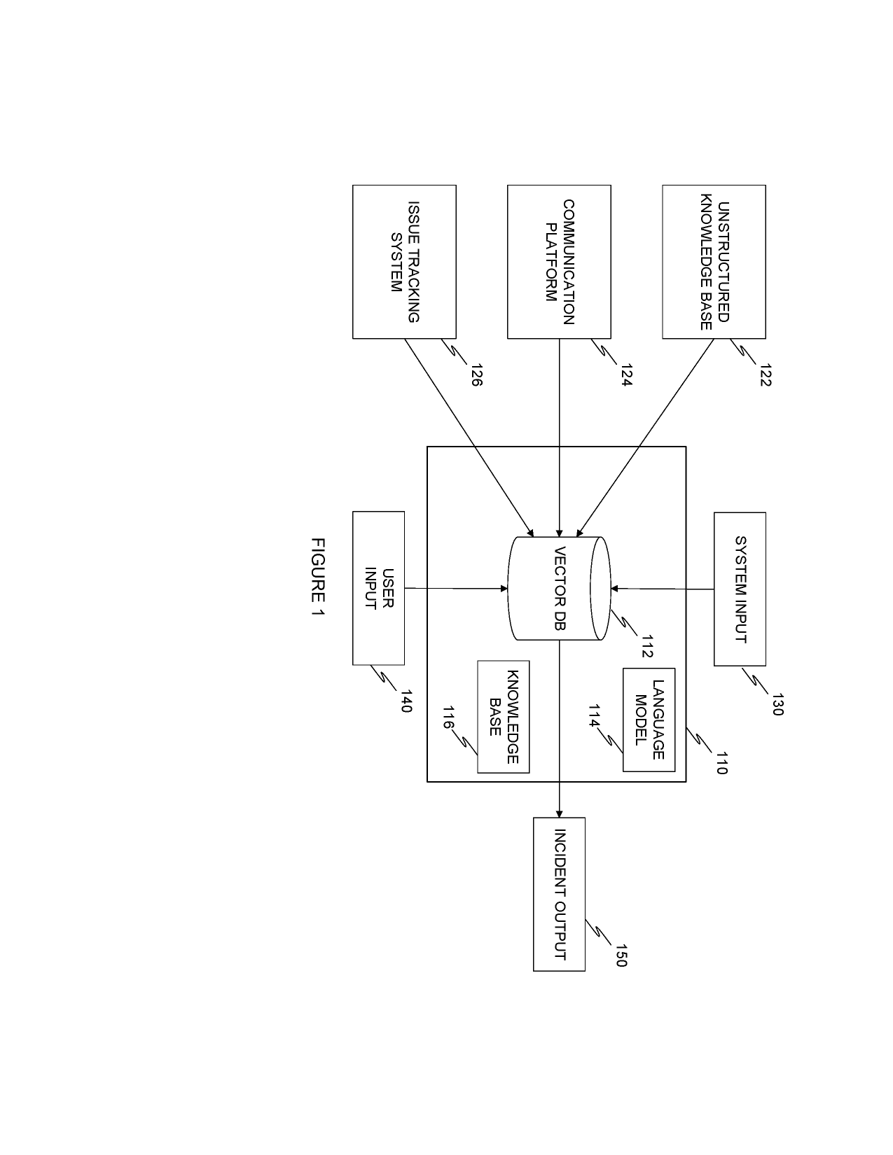

FIG. 1 is an example schematic diagram of an artificial intelligence (AI) co-pilot system for incident management, implemented in accordance with an embodiment. In an embodiment, an incident management system 110 is implemented in a cloud computing environment, utilizing, for example, a virtual machine, a software container, a serverless function, a combination thereof, and the like.

In some embodiments, the incident management system 110 is configured to communicate with, access, and the like, a plurality of data sources. According to an embodiment, a data source includes a knowledge base 122 of unstructured data, a communication platform 124, an issue tracking system 126, a combination thereof, and the like.

In an embodiment, a knowledge base 122 is implemented using a content management system, such as a wiki. In some embodiments, the knowledge base 122 is implemented to include a runbook, a knowledge base (KB) article, a standard operating procedure (SOP), an after action review (AAR), various combinations thereof, and the like. In some embodiments, the knowledge base 122 includes structured knowledge (e.g., a columnar database), unstructured knowledge (e.g., files, documents, etc.), a combination thereof, and the like.

In certain embodiments, the communication platform 124 is a communication platform utilized by an organization in a computing environment, such as a virtual private cloud environment. In some embodiments, the communication platform 124 is implemented utilizing Slack®, Microsoft® Teams, and the like. In an embodiment, the communication platform 124 includes a data store of communication between various user accounts of the organization, of a plurality of organizations, etc., and the like. In some embodiments, the communication includes a plurality of messages, each message associated with a text and a user account to which the text is attributed (i.e., a user account which generated the text of the message).

In some embodiments, the communication includes a plurality of messages, wherein the messages are arranged in channels, groups, and the like, and each channel, for example, is associated with at least a user account. Each user account associated with the channel includes a permission to view messages in the channel, edit messages in the channel, generate messages in the channel, delete messages in the channel, a combination thereof, and the like.

According to an embodiment, the incident management system 110 is further configured to access an issue tracking system 126. In an embodiment, accessing an issue tracking system 126 includes receiving alerts from the issue tracking system 126, receiving incident reports from the issue tracking system 126, reading tickets generated by the issue tracking system 126, a combination thereof, and the like.

In an embodiment, an issue tracking system 126 is, for example, ServiceNow®, Jira®, and the like. According to an embodiment, the issue tracking system 126 is configured to associate a ticket, an issue, and the like, with a user account, such as a user account utilizing the communication platform 124.

In some embodiments, the incident management system 110 is configured to generate a vector representation based on data extracted from each data source. For example, in an embodiment, the incident management system 110 is configured to generate a vector in a vector database 112 based on an article in a KB, a portion of an article in the KB (e.g., a paragraph), etc. In an embodiment, the incident management system 110 includes a knowledge base 116 which stores thereon a representation of a computing environment, a representation of entities of the knowledge base 122, of the communication platform 124, of the issue tracking system 126, and the like. In an embodiment, the knowledge base 116 is further utilized by the incident management system 110 to generate a context for the language model 114.

As another example, the incident management system 110 is configured, in certain embodiments, to generate a vector representation based on a message, a plurality of messages, etc., selected from a communication platform 124. In certain embodiments, the vector representation is generated based on a group of messages clustered based on a temporal value, based on a semantic similarity, etc.

In certain embodiments, the incident management system 110 is also configured to generate a vector representation for a ticket, an issue, an alert, and the like, which is received, accessed, etc., from an issue tracking system 126. In some embodiments, the vectors are stored in a vector database 112, implemented for example using Chroma®, Vespa®, Milvus®, and the like.

In some embodiments, a language model 114 is utilized to generate a vector, for example based on data from the data sources. In certain embodiments, the language model 114 is configured to process an input, a context, and a prompt which when processed by the language model 114 configure the incident management system 110 to generate a vector based on the same.

For example, according to an embodiment, a language model 114 is a large language model, a small language model, and the like. A language model is for example OpenAI® GPT, Google® Bard, Meta® LLaMA, and the like. These language models power technologies like chatbots (e.g., ChatGPT), virtual assistants (e.g., Alexa), translation tools (e.g., Google Translate), and content generation platforms.

In an embodiment, the incident management system 110 is configured to receive a system input 130, a user input 140, a combination thereof, and the like. In an embodiment, a system input 130 includes a data record such as an issue, a ticket, an alert, an incident report, a real-time event, a combination thereof, and the like. In some embodiments, a user input 140 is a user-generated input. In an embodiment, the user input 140 is associated with a user account, a role, a communication platform 124, a combination thereof, and the like.

In certain embodiments, the user input 140 includes a natural language query, statement, etc. In an embodiment, a natural language query is provided in human language, i.e., language which is not intended for execution by a computing system. In some embodiments, a natural language query is not a structured query, e.g., not a query such as a SQL query, a NoSQL query, and the like.

In an embodiment, the incident management system 110 is configured to generate an action plan. In some embodiments, the incident management system 110 is configured to adapt an action plan, for example based on a system input 130, a user input 140, etc.

In some embodiments, the system 110 is configured to generate a prompt for a language model 114 which selects an action plan based on a system input 130, a user input 140, a generated context, a combination thereof, and the like. For example, in an embodiment, context is generated based on the system input 130, the user input 140, a combination thereof, etc., and extracted from the KB 122, the communication platform 124, the issue tracking system 126, a combination thereof, and the like.

According to an embodiment, an action plan includes an action, an instruction, executable code, a code script, etc., which is executed in a computing environment in response to detection, for example, of an incident.

In an embodiment, the system 110 is configured to select an action plan based on a similarity determined between a vector representing the action plan and a vector representing an input, such as user input 140, system input 130, a combination thereof, and the like. In some embodiments the system 110 is configured to generate an incident output 150. In an embodiment, the incident input 150 is provided, for example, to the communication platform 124. In certain embodiments, additional inputs are received by the system 110 based on an interaction with the incident output 150, which in turn configures the system 110 to generate another incident output, and provide the same to a data source of the plurality of data sources.

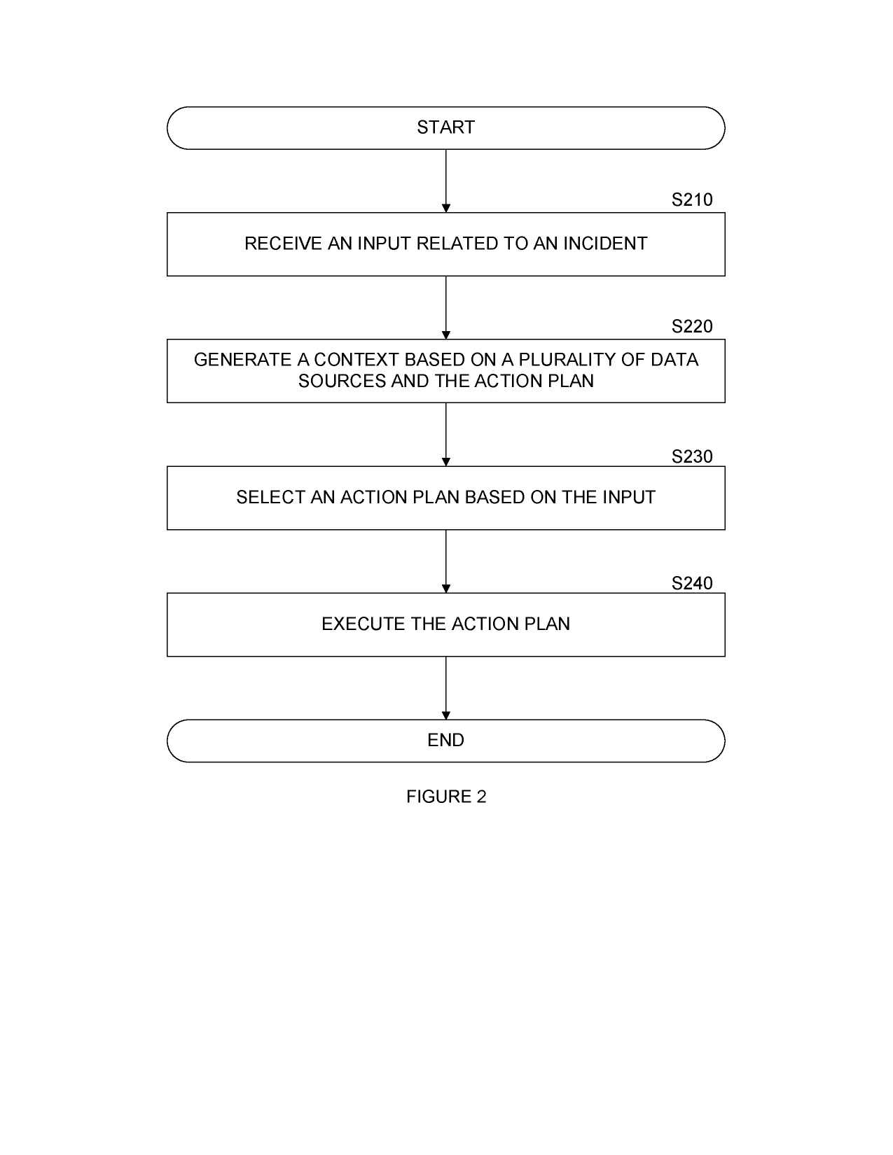

FIG. 2 is an example flowchart of a method for selecting an action plan in incident management, implemented in accordance with an embodiment.

At S210, an input is received. In an embodiment, the input is related to an incident occurring in a computing environment. In some embodiments, the input is a system input, a user input, a combination thereof, and the like.

For example, in an embodiment, a user input is a query, including a natural language query. In an embodiment, a natural language query includes text which is unstructured, and not executable by a computer system, such as a database management system.

In certain embodiments, a system input is an incident report, an alert, a notification, a ticket, an issue, a combination thereof, and the like, which is received by a system configured to detect issues, a system configured to generate tickets, a combination thereof, and the like.

In an embodiment, the input is vectorized into a feature space and stored in a vector database. According to an embodiment, an input is vectorized into a plurality of vectors, each having its own feature space (i.e., embedding). In some embodiments, vectorizing an input is performed by a language model, generative AI, and the like, which is configured to vectorize the input based on a predetermined embedding and a prompt which includes the input.

At S220, an action plan is selected. In an embodiment the action plan is selected based on the input. In some embodiments, a generative AI is configured to receive a prompt, and select an action plan based on a result of processing the prompt by a generative AI model, such as a language model.

In an embodiment, the action plan, an element of the action plan, etc., is vectorized, and the generative AI is configured to select an action plan based on a similarity between the input, the context, and the action plan, based on a distance between the vectors of each (i.e., the plan that minimizes such a distance is selected).

According to an embodiment, an action plan includes an action, an instruction, a script, a query, a database query, a SQL query, a NoSQL query, a combination thereof, and the like, which is executable in the computing environment. In an embodiment, the action plan is adapted based on the input. For example, according to some embodiments, the action plan is adapted based on the input by a generative AI configured to process a prompt which outputs an adapted action plan.

In some embodiments, a plurality of action plans are selected. In certain embodiments, the action plan includes a plurality of actions which are executed sequentially. For example, in an embodiment, an action includes a condition corresponding to execution of a previous action of the action plan, such that if the condition is met the next action is not executed, and if the condition is not met, the next action is executed. According to an embodiment, an action plan is selected based on a semantic similarity to the input.

At S230, a context is generated. In an embodiment, the context is generated for retrieval augmented generation. In some embodiments, the context is generated based on a plurality of data sources, the selected action, a combination thereof, and the like.

In an embodiment, a data source is a knowledge base (KB) including a plurality of KB articles, each article including a text. In some embodiments, a data source is a communication platform, the communication platform including a plurality of channels, each channel associated with at least a user account authorized to view, edit, delete, etc., messages in the channel. In an embodiment, a data source is an issue tracking system. According to an embodiment, an issue tracking system is configured to generate tickets, alerts, incident reports, and the like.

In an embodiment, the context is generated by vectorizing data from a data source, and selecting a data from a data source based on a distance between a vector representing the data, and a vector representing the input.

For example, according to an embodiment, the distance is a cosine distance between the vectors (i.e., cosine similarity) such that a smaller distance indicates that a pair of vectors are more likely to be related than a pair of vectors having a larger distance between them.

At S240, the action plan is executed. In an embodiment, the action plan is executed in a computing environment, in a plurality of computing environments, etc. In some embodiments, the action plan is executed in the data sources. For example, in an embodiment the action plan includes an action which when executed generates a message in a channel of a communication platform.

According to an embodiment, the action plan includes a plurality of actions, each of which is adapted to an input, based on a system input, a user input, a combination thereof, and the like.

In certain embodiments, a first action plan is executed at a first phase of an incident management, and a second action plan is executed at a second phase of the incident management.

In some embodiments, the methods described herein are iterated continuously, in parallel, etc., such that outputs of certain steps feed into inputs of certain other steps. For example, an action plan is selected which includes multiple actions, some of which have their own action plans which are then executed based on a larger-scope action plan.

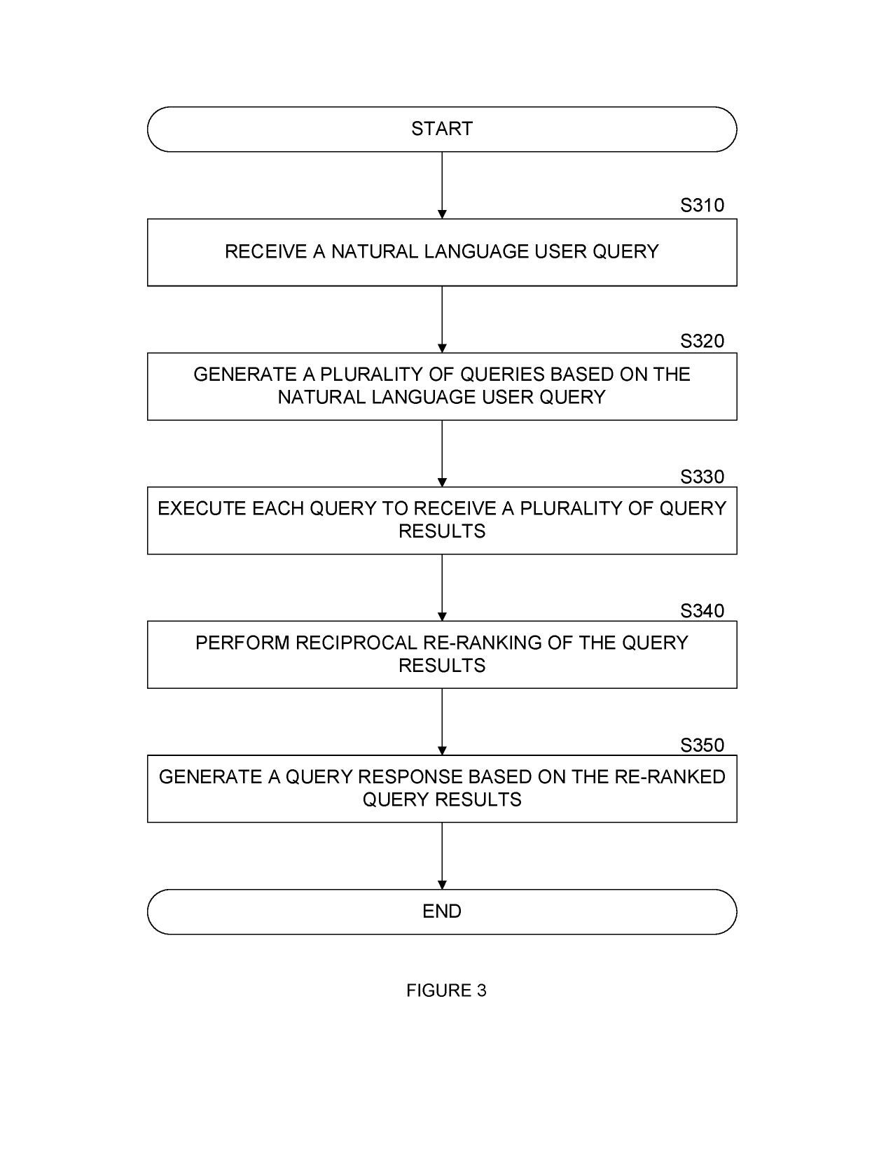

FIG. 3 is an example flowchart of a method for increasing efficacy of generating a response to a user query utilizing a generative artificial intelligence, implemented in accordance with an embodiment.

At S310, an input is received. In an embodiment, the input includes a natural language query. According to an embodiment, a natural language query includes text which is unstructured, and not executable by a computer system, such as a database management system.

In an embodiment, the input is vectorized into a feature space and stored in a vector database. According to an embodiment, an input is vectorized into a plurality of vectors, each having its own feature space (i.e., embedding). In some embodiments, vectorizing an input is performed by a language model, generative AI, and the like, which is configured to vectorize the input based on a predetermined embedding and a prompt which includes the input.

At S320, a plurality of queries are generated. In an embodiment, a generative AI model, such as a large language model (LLM) is configured to generate a plurality of queries based on a prompt including the received input and a context.

In some embodiments, the context includes context generated based on a data source of a plurality of data sources of a specific computing environment. For example, a context includes, according to an embodiment, a schema of a computing environment, a schema of a database on which to execute the query, a combination thereof, and the like.

In certain embodiments, each of the queries is generated to be unique respective of the other queries, so that no two queries are identical. In some embodiments, the queries are prompts for applying on a language model of a generative AI system. In an embodiment, each prompt is configured to select a data source, a data element from a data source, etc., from a plurality of data sources.

According to an embodiment, each prompt is configured to select a data source, a data element, a plurality of data sources, a plurality of data elements, etc., as candidates for retrieval augmented generation of a response based on the received input.

At S330, the plurality of queries are executed. In an embodiment, executing a query, a prompt, etc., includes processing a prompt by a generative AI system, for example utilizing a large language model. In an embodiment, LLM is a pre-trained model, a fine-tuned model, etc.

In an embodiment, executing a query, processing a prompt, and the like, generates an output. In an embodiment, the output includes a selection of a data element, selection of a data source, selection of a plurality of data elements, selection of a plurality of data sources, a combination thereof, and the like.

In an embodiment, selecting a data element, data source, and the like, is performed based on a detected similarity between the query and, for example, the data element. According to an embodiment, similarity is determined based on a distance between a vector representing the query and a vector representing the data element.

At S340, a reciprocal re-ranking is performed. In an embodiment, reciprocal re-ranking is performed based on performing a vector search, a keyword search, a combination thereof, etc., of a data source, to detect a data element. In an embodiment, this allows to promote content (i.e., data elements) which repeat between data sources, giving such data elements a higher score when determining a match between a query and a data element.

At S350, a query response is generated. In an embodiment, the response is generated based on data elements having a rank higher than a predetermined threshold rank from the plurality of data elements which were reciprocally re-ranked.

According to an embodiment, a query response includes generating a prompt for a generative AI, generating a database query in a database query language for execution by a database management system (DBMS), a combination thereof, and the like.

In an embodiment, generating a response based on re-ranked data elements allows to provide a response having a higher accuracy. This is due to assigning more weight to results which returned, matched, etc., the multiple generated queries.

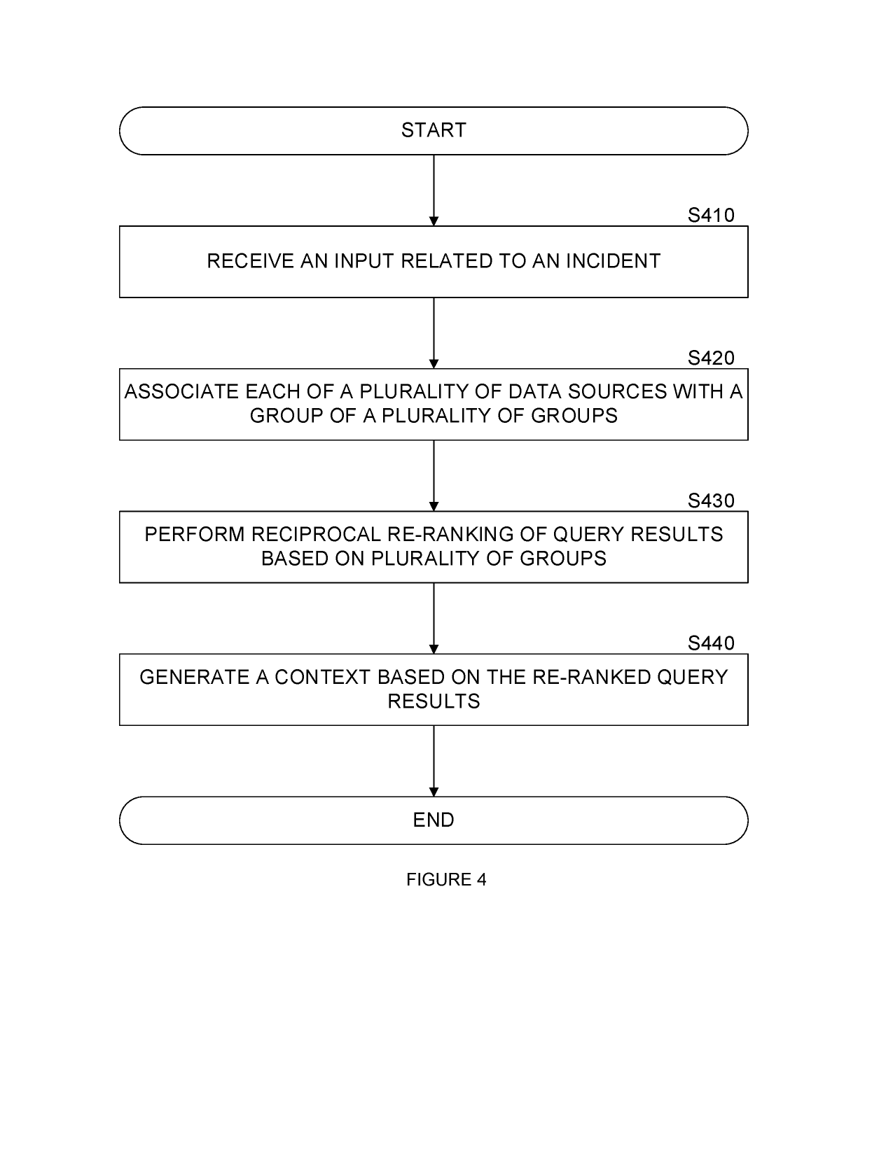

FIG. 4 is an example flowchart of a method for improving retrieval augmented generation for a generative artificial intelligence system, implemented according to an embodiment.

At S410, an input is received. In an embodiment, the input is related to an incident occurring in a computing environment. In some embodiments, the input is a system input, a user input, a combination thereof, and the like.

For example, in an embodiment, a user input is a query, including a natural language query. In an embodiment, a natural language query includes text which is unstructured, and not executable by a computer system, such as a database management system.

In certain embodiments, a system input is an incident report, an alert, a notification, a ticket, an issue, a combination thereof, and the like, which is received by a system configured to detect issues, a system configured to generate tickets, a combination thereof, and the like.

In an embodiment, the input is vectorized into a feature space and stored in a vector database. According to an embodiment, an input is vectorized into a plurality of vectors, each having its own feature space (i.e., embedding). In some embodiments, vectorizing an input is performed by a language model, generative AI, and the like, which is configured to vectorize the input based on a predetermined embedding and a prompt which includes the input.

At S420, a plurality of data groups are generated. In an embodiment, a data group includes a plurality of data sources. For example, according to an embodiment, data sources are grouped by type.

In an embodiment, a type of a data source is, for example, a knowledge base type, a communication platform type, an issue tracking system type, a combination thereof, and the like.

According to an embodiment, a data source is grouped with another data source based on semantic similarity of the content provided thereby. In certain embodiments, a data source is grouped with other data sources based on a predetermined type of data source assigned to each data source.

In an embodiment, a plurality of queries are generated based on a received incident input. In some embodiments, each query of the plurality of queries is executed respectively of a unique data group.

At S430, a reciprocal re-ranking is performed. In an embodiment, reciprocal re-ranking is performed based on performing a vector search, a keyword search, a combination thereof, etc., of a data source, to detect a data element. In an embodiment, this allows to promote content (i.e., data elements) which repeat between data sources, giving such data elements a higher score when determining a match between a query and a data element.

According to an embodiment, reciprocal re-ranking is performed based on the generated plurality of groups, such that results from a first group are ranked respectively with results from a second group. This allows to increase variance in generating a response from multiple types of data sources, while fetching only the most relevant information from each data source group.

At S440, a context is generated. In an embodiment, the context is generated by selecting a data element from each data group. In some embodiments, a result, output, etc., is generated for the received input based on the context. In an embodiment, the context is utilized in generating the output by processing the context, a prompt, the received incident input, a combination thereof, and the like, by a language model of a generative AI system.

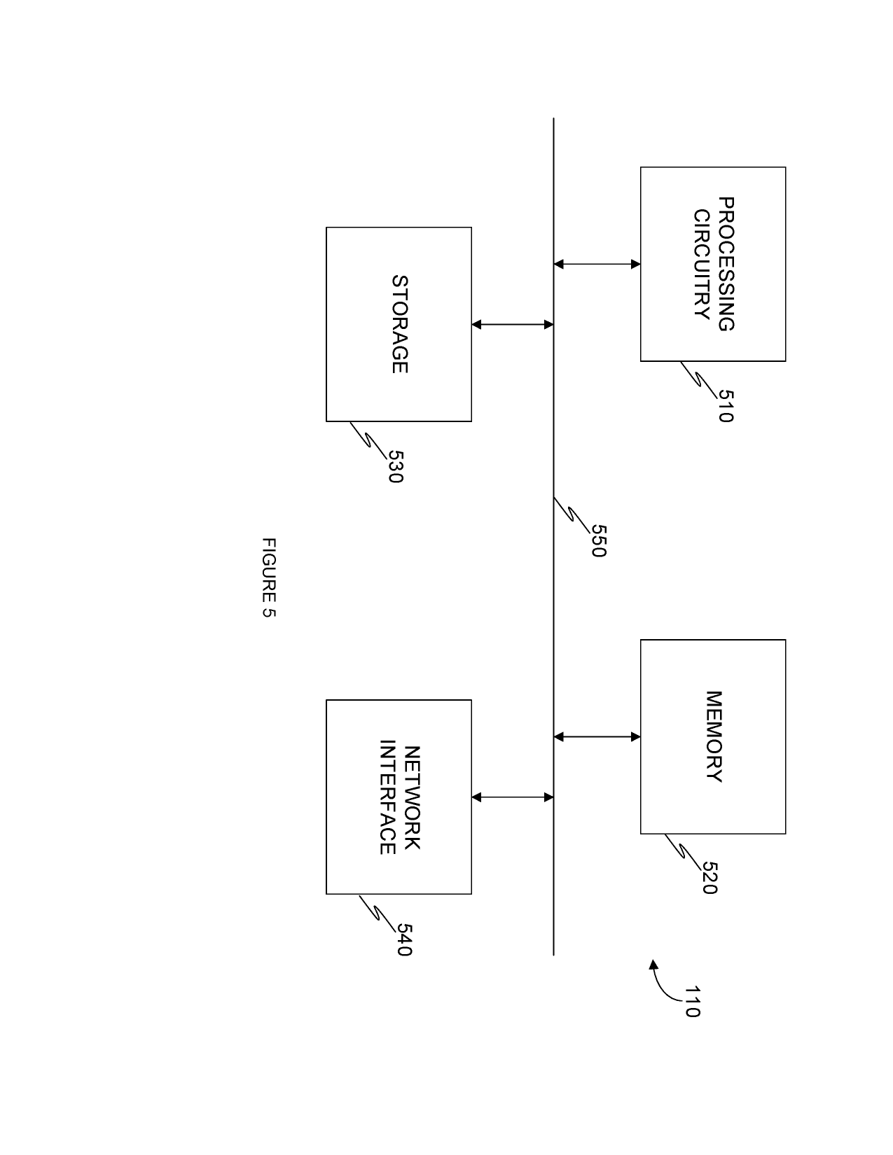

FIG. 5 is an example schematic diagram of a system 110 according to an embodiment. The system 110 includes, according to an embodiment, a processing circuitry 510 coupled to a memory 520, a storage 530, and a network interface 540. In an embodiment, the components of the system 110 are communicatively connected via a bus 550.

In certain embodiments, the processing circuitry 510 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 520 is a volatile memory (e.g., random access memory, etc.), a non-volatile memory (e.g., read only memory, flash memory, etc.), a combination thereof, and the like. In some embodiments, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein is stored in the storage 530, in the memory 520, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 510, cause the processing circuitry 510 to perform the various processes described herein, in accordance with an embodiment.

In some embodiments, the storage 530 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 540 is configured to provide the system 110 with communication with, for example, KB 122, the communication platform 124, the issue tracking system 126, and the like, according to an embodiment.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for incident management in a computing environment utilizing generative artificial intelligence (AI) system, comprising:
receiving an incident input, the incident associated with a computing environment including a plurality of data sources;
selecting an action plan of a plurality of predefined actions plans based on a result of processing a prompt, the context, and the incident input by the generative AI system, the action plan including a plurality of actions;
generating a context for a generative AI model based on the incident input and data from at least a data source of the plurality of data sources; and
executing at least an action of the action plan in the computing environment.

2. The method of claim 1, further comprising:
modifying an action of the action plan based on the received incident input.

3. The method of claim 2, further comprising:
generating a prompt for the generative AI system which when processed by the AI model outputs a modified action of the action plan.

4. The method of claim 1, further comprising:
generating the context based on a plurality of data sources.

5. The method of claim 4, further comprising:
extracting a plurality of data elements from each of the plurality of data sources, each data element ranked by similarity to at least the incident input;
re-ranking the plurality of data elements to reduce redundancy based on at least a data source; and
generating the context based on a group of re-ranked data elements of the plurality of data elements.

6. The method of claim 5, further comprising:
generating a plurality of data groups, each data group including a group of data sources of the plurality of data sources; and
re-ranking the plurality of data elements further based on at least a data group.

7. The method of claim 1, further comprising:
selecting a data element of a data source based on a similarity ranking to the received incident input.

8. The method of claim 7, further comprising:
generating a vector representation of the data element;
generating a vector representation of the incident input; and
determining the similarity ranking based on a distance between the vector representation of the data element and the vector representation of the incident input.

9. The method of claim 8, further comprising:
configuring the generative AI system to generate vector representations based at least on a schema of a vector database.

10. A non-transitory computer-readable medium storing a set of instructions for incident management in a computing environment utilizing generative artificial intelligence (AI) system, the set of instructions comprising:
one or more instructions that, when executed by one or more processing circuitries of a device, cause the device to:
receive an incident input, the incident associated with a computing environment including a plurality of data sources
select an action plan of a plurality of predefined actions plans based on a result of processing a prompt, the context, and the incident input by the generative AI system, the action plan including a plurality of actions
generate a context for a generative AI model based on the incident input and data from at least a data source of the plurality of data sources; and
execute at least an action of the action plan in the computing environment.

11. A system for incident management in a computing environment utilizing generative artificial intelligence (AI) system comprising:
one or more processing circuitries configured to:
receive an incident input, the incident associated with a computing environment including a plurality of data sources
select an action plan of a plurality of predefined actions plans based on a result of processing a prompt, the context, and the incident input by the generative AI system, the action plan including a plurality of actions
generate a context for a generative AI model based on the incident input and data from at least a data source of the plurality of data sources; and
execute at least an action of the action plan in the computing environment.

12. The system of claim 11, wherein the one or more processing circuitries are further configured to:
modify an action of the action plan based on the received incident input.

13. The system of claim 12, wherein the one or more processing circuitries are further configured to:
generate a prompt for the generative AI system which when processed by the AI model outputs a modified action of the action plan.

14. The system of claim 11, wherein the one or more processing circuitries are further configured to:
generate the context based on a plurality of data sources.

15. The system of claim 14, wherein the one or more processing circuitries are further configured to:
extract a plurality of data elements from each of the plurality of data sources, each data element ranked by similarity to at least the incident input;
re-rank the plurality of data elements to reduce redundancy based on at least a data source; and
generate the context based on a group of re-ranked data elements of the plurality of data elements.

16. The system of claim 15, wherein the one or more processing circuitries are further configured to:
generate a plurality of data groups, each data group including a group of data sources of the plurality of data sources; and
re-rank the plurality of data elements further based on at least a data group.

17. The system of claim 11, wherein the one or more processing circuitries are further configured to:
select a data element of a data source based on a similarity ranking to the received incident input.

18. The system of claim 17, wherein the one or more processing circuitries are further configured to:
generate a vector representation of the data element;
generate a vector representation of the incident input; and
determine the similarity ranking based on a distance between the vector representation of the data element and the vector representation of the incident input.

19. The system of claim 18, wherein the one or more processing circuitries are further configured to:
configure the generative AI system to generate vector representations based at least on a schema of a vector database.
